(19) United States
(12) Patent Application Publication
(10) Pub. No.: US 2013/0006479 A1
(43) Pub. Date: Jan. 3, 2013

(54) Microchip System and Method for Operating a Locking Mechanism and for Cashless Transactions

(76) Inventor: Gerald G. Anderson, Fresno, CA (US)

(21) Appl. No.: 13/543,584

(22) Filed: Jul. 6, 2012

Related U.S. Application Data
(63) Continuation-in-part of application No. 13/029,880, filed on Feb. 17, 2011, now abandoned.
Application No. 13/029,880 is a continuation-in-part of application No. 12/573,872, filed on Oct. 5, 2009, now abandoned.
(60) Provisional application No. 61/230,079, filed on Jul. 30, 2009.

(51) Int. Cl. E05B 65/20; G06F 17/00

(52) U.S. Cl. 701/49

(57) ABSTRACT

A system for and method to lock or unlock a locking mechanism with a microchip that is associated with a user of the locking mechanism. In one embodiment, the locking mechanism is associated with a vehicle to allow the user to automatically control the vehicle's alarm system and one or more doors of the vehicle. The microchip is placed in a cell phone, USB drive or other device or implanted in the user. A chip-reading mechanism electronically communicates with the microchip and with an electronic controller that controls the locking mechanism. When the user exits the vehicle, the alarm is activated and the doors are locked by the user waiving the microchip over the chip-reading mechanism or by using a proximity circuit. When the user approaches the vehicle the alarm is deactivated and the driver's door is unlocked. Other operations of the vehicle can also be controlled using the microchip.

### CROSS-REFERENCE TO RELATED APPLICATIONS

This patent application is a continuation-in-part of U.S. patent application Ser. No. 13/029,880 filed Feb. 17, 2011, which was a continuation-in-part of U.S. patent application Ser. No. 12/573,872 filed on Oct. 5, 2009, which claims priority to U.S. Provisional Patent Application No. 61/230,079 filed Jul. 30, 2009.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

A. Field of the Invention

The field of the present invention relates generally to debit and credit cards and other electronic devices and the use thereof to facilitate purchases and the like. In particular, the present invention relates to systems and methods for allowing the user to add monetary value or otherwise increase the spending limit capability of a microchip that is implanted in their body or in an electronic device. Even more particularly, this invention relates to such systems and methods that also allow the user to operate a locking mechanism that can be utilized, as an example to access and/or control a vehicle using the microchip that is associated with the user.

B. Background

Many products and services are available for purchase through an automated vending machine that allows a person to obtain the desired product or service by inserting a debit or credit card into the machine, or by otherwise interacting with the machine, and then selecting the desired product or service. Examples of commonly utilized automated vending machines include gasoline dispensing machines, food and/or drink vending machines, stamps and car/truck washing. Purchases are also made at cash register types of machines where the person buying the product or service either slides his or her debit/credit card through a card reader or hands the card to a clerk or other employee who uses the card to register the purchase. Examples of cash register types machines include those at grocery and department stores, convenience markets, fast food or other take-out eateries, dine-in restaurants, sporting goods stores, electronic stores, spas, beauty parlors and a wide variety of other types of stores that sell products or services. Other machines, commonly referred to as ATMs, allow the user to utilize his or her debit/credit card to check his or her bank balance, make deposits and/or withdraw cash. Although not exclusively, ATMs are frequently associated with a bank or banking-like institution. ATMs are also placed in malls, stores, amusement parks, casinos and other locations where people tend to spend money so they can obtain more cash when needed. For purposes of the present disclosure, the term “transaction machine” is utilized to collectively refer to automated vending machines, cash register type machines, ATMs and similarly configured machines, all of which have in common the fact that a person or someone on his or her behalf uses a debit/credit card to access the transaction machine to purchase goods and services, engage in a transaction with a bank or other financial institution or to accomplish similar transactions.

The primary benefit of transaction machines is convenience for the user and lower employee costs and quicker payment for the business utilizing the transaction machine. In fact, the benefits of transaction machines have made these a nearly irreplaceable staple of modern life. No longer does a person have to worry about whether he or she has sufficient cash on their person or have to engage an operator or other person to obtain certain goods or services (i.e., to vend gasoline from a pump, obtain cash from a bank, etc.). Another primary benefit of transaction machines has been the elimination of the need to write a check to make a purchase, which eliminates the need to transfer the check from the location where the check was presented to the bank or other financial institution that will honor or otherwise pay the check. This has saved businesses and their customers significant cost and time.

Transaction machines print and dispense a receipt that shows the items that were purchased, the payment from the purchaser's account and/or other details of the transaction. Most people expect and desire a record of the transaction so they may verify the purchase or have the receipt available if they must return or exchange the product. Most businesses require a copy of the receipt in order for their employees to obtain reimbursement for business-related expenses. In addition, the IRS and state tax agencies require receipts to verify tax-deductible costs. As such, obtaining a receipt from the transaction machine is presently considered an integral part of the use of the transaction machine by most persons who utilize such machines.

A major issue with regard to transaction machines is the cost and environmental unfriendliness of the paper receipts. As well known to those in the transaction machine business, the cost of the paper, ink and other supplies to print receipts is not an insignificant amount. In addition, printing of receipts requires more maintenance for the transaction machine. To compound the issue, although many people hold onto and use the transaction machine receipts, a significant number of people only briefly look at the receipt to verify the amounts and then discard the receipt. Those persons who desire or need to keep the receipt for reimbursement, tax or other purposes have to place the receipt in a location where it can be later retrieved. Unfortunately, it is not uncommon to lose the receipt, thereby negating the whole purpose of getting the receipt. Improperly disposed receipts create litter problems and those receipts which do end up in the trash must then be transferred to a waste processing facility or disposed of in a landfill or the like. Use of ink and paper utilizes natural resources that could be put to much better use. For instance, the many millions of transaction machines in use no doubt utilize a significant amount of paper, which results in an increase in tree harvesting and less trees available for oxygen production. As a result of the above, the printing and dispensing of the receipts from transaction machines is generally considered to be in conflict with the public's desire to have more environmentally friendly or “green” products and services. Previously-filed U.S. patent application Ser. No. 12/573,872, filed by the present inventor, describes an improved machine and process of paperless receipts that are beneficially utilized by users to obtain a receipt for purchases made with the user's debit/credit card. As set forth in the above-identified patent application, the transaction machine is configured with a USB port that receives a user's USB drive and/or a keypad or touch screen configured to allow the user to input his or her email address. Instead of printing the receipt, the user selects whether he or she wants the electronic transaction receipt transmitted to the USB drive through the USB port or to his or her email address via the Internet.

Another major issue with regard to transaction machines is the fact that the user's debit or credit card must have sufficient resources, in the form of a bank account balance for debit cards or credit limit for credit cards, available to the user for the purchase. Failure to have the sufficient resources available at the time of the purchase often results in the purchase being denied, which typically causes embarrassment to the user and may result in a lost opportunity to make the desired purchase. In some circumstances, the purchase goes through but the user is hit with a charge for overdraft of the account associated with the debit card or exceeding the credit limit of the credit card. The holder of the debit/credit card can ensure that his or her purchases will be approved by having sufficient funds in or sufficient credit available with his or her account.

The present arrangement for debit/credit cards is that the entire bank account balance associated with the debit card or the entire credit limit of the credit card is available to the holder of the credit card when he or she uses it. As most people do not have a separate debit/credit card with a low balance or limit, the funds available can be somewhat high. As well known, however, having a debit/credit card with a high amount of available balance or available credit is risky if the card is stolen or the account is accessed or otherwise used by others without permission of the card holder. This risk is somewhat higher when the holder is traveling, particularly out of the country, which is also when the holder usually most desires to have the funds available to him or her for their own use. In addition to stealing the debit/credit card and then using it, thieves have also been known to hack into or otherwise illegally access account information from a transaction machine, such as by providing a “fake” machine that is configured to gather account and password information, and use that information to remove money from the account or charge items to the credit card. In addition to the foregoing, many people make payments for goods and/or services online, such as over the Internet, or on the telephone that require the holder to provide their debit/credit card information to a person or company they do not know. Naturally, this can also result in misuse of the debit/credit card information to access the holder's account. Access to the holder's entire bank account or credit limit can result in significant financial loss or liability for the debit/credit card holder.

Gift cards or credit card company sponsored cards having a fixed amount of funds are purchased so they can be used later either by the purchaser for his or her purchases or, more commonly, are given as gifts by the purchaser to allow others to make purchases. Typically, these cards are available in pre-set (e.g., $10.00, $25.00, $50.00 or etc.) or purchaser selected dollar denominations. As long as the total amount of the card is not exceeded, these cards can be used to make multiple purchases. Once the cards are fully used, meaning the fixed amount of funds thereon have been spent, the cards are typically thrown away or otherwise discarded. Although these cards have the advantage of limiting any potential loss or misuse of the card to the set denomination of the card, use of the cards requires a purchaser to go to the effort of purchasing a card at a store and results in a waste of materials when the card is fully used up. Further use of this type of card is not possible. To repeat the benefits of this type of card requires the user to purchase or obtain a new card.

As well known, most people carry one or more sets of keys or other devices to open and control the operation of a locking mechanism, such as those used to allow or prevent entry into a motor vehicle, structure or area (such as a safe, locker or fenced yard). With regard to motor vehicles, locking mechanisms are used to access and control the operation of the motor vehicle, including cars, trucks, motorcycles and the like. Many people carry a plurality of keys, such as house keys and vehicle keys, in one of their pants pockets, which is known to be somewhat uncomfortable. Although the keys can be carried in a briefcase, purse, satchel or the like, the keys can get mixed up with other items that are being carried and can, at times, be somewhat difficult to locate. Either way, the keys tend not to be insignificant with regard to bulk and/or weight. Although many motor vehicle manufacturers now provide vehicles that utilize electronic entry and control mechanisms that recognize a cooperatively configured control device, such as a fob or the like, that is utilized for the vehicle's key entry and ignition systems, the user must still carry the fob on his or her person or in a briefcase, purse, satchel or the like. The fob is used to electronically, depending on which button is pushed, open the doors, trunk and/or fuel door and to activate or deactivate the vehicle's alarm system. In some vehicle configurations, the fob can also be utilized to start the vehicle's engine and/or lower windows.

What is needed, therefore, is an improved system and method for limiting the amount of cash available to be accessed by a debit card, credit to be charged to a credit card or otherwise electronically accessible so as to limit the potential loss or liability to the account holder. Such a system and method should allow the user to be able to have a desired amount of funds available on his or her debit/credit card or other electronic device for use when he or she wants to make a purchase without allowing access to his or her entire bank account or credit limit. Such a system and method should be configured to allow the account holder to refill and reuse his or her card or other electronic device with a desired amount of funds so that amount of money, but only that amount, is available for his or her purchases. Preferably, the system and method would be configured to be utilized with existing transaction machines and/or debit/credit cards or with new transaction machines, debit/credit cards and/or other electronic devices that are beneficially configured to be utilized with the present invention. The system and method should also be configured to be utilized with transaction machines that are configured to allow the user to obtain paperless receipts. Additionally, the system and method should allow the user to easily lock or unlock a locking mechanism without having to utilize keys, codes or passwords. In addition, the system and method should allow the user to easily lock the vehicle doors and activate the alarm and then deactivate the alarm, gain access to the vehicle and operate one or more features of the vehicle.

### SUMMARY OF THE INVENTION

The microchip system and method for accessing and controlling a vehicle and for cashless transactions of the present invention provides the benefits and solves the problems identified above. That is to say, the present invention discloses a system and method that allows a person to easily lock or unlock a locking mechanism without the use of keys, codes or passwords. In one embodiment, the present invention discloses a system and method that allows a person to activate and deactivate a vehicle alarm system and to lock and unlock one or more doors of the vehicle using a microchip placed in a device, such as a cell phone or the like, or embedded in the user. The microchip associates the user with the vehicle such that only the microchip carried by or in the user will control the alarms and the doors. The system and method of the present invention also allows the user to control the operation of various other vehicle components, such as the trunk, hood, windows and/or fuel door. In addition, the present system and method allows the user to place a desired, but limited amount, of funds on his or her debit/credit card or other electronic cash device so as to have those funds available for purchases without risking access to his or her entire bank account, credit limit or other source of funds. The system and method of the present invention allows the account holder to purchase goods and/or services or arrange for other payments using a debit/credit card or other electronic cash device that has a limited amount of funds or credit limit thereon so if anyone misuses the card information they can only have access to the amount the user placed on the debit/credit card or other electronic cash device instead of his or her entire bank account or credit limit. The system and method of the present invention is adaptable to be utilized with existing transaction machines and/or debit/credit cards or it can be configured to be utilized with new transaction machines, debit/credit cards or other electronic cash devices that are specifically configured to be utilized with the present invention. The system and method of the present invention can be utilized with transaction machines configured to allow the user to obtain paperless receipts so as to reduce paper produced by such machines.

In a primary embodiment of the present invention, the rechargeable cash replacement system generally comprises an electronic cash device, an authorized user of the electronic cash device, a bank account and/or a credit limit that is associated with the electronic cash device and the authorized user, and a transaction machine that is configured to interact with or read the electronic cash device and electronically transfer funds from at least one of the bank account and the credit limit to the electronic cash device so as to establish available funds for use by the authorized user for his or her proposed transaction, such as to make a purchase, payment or the like. The electronic cash device can be a debit/credit card, an appropriately configured USB drive or a microchip, which is disposed in another device or implanted in the user's body. The proposed transaction can be made through a transaction machine, the Internet, telephone or the like. The electronic cash device is configured to allow access to the available funds that are associated with the electronic cash device for the proposed transaction without allowing access to the bank account and the credit limit. Preferably, the system is configured such that the transaction machine requires the authorized user to comply with one or more security measures, such as entering a password or allowing his or her fingerprint or eye to be scanned, prior to transferring the funds to the electronic cash device.

The transaction machine has a machine body with at least one of a display panel and a keypad on an outer surface of the machine body, a USB port on the outer surface of the machine body accessible to the authorized user and configured to electronically communicate with a USB drive that is provided by the authorized user when he or she is utilizing the transaction machine and means for transmitting an electronic transaction receipt to at least one of the USB drive or an email address. Preferably, the display panel and the keypad are configured to transmit transaction information between the transaction machine and the authorized user such that the email address can be entered into the transactional machine utilizing the display panel and/or keypad. The email address is stored on the USB drive and associated with the authorized user and/or the USB drive contains information identifying the user of the transaction machine to allow the user to conduct transactions with the transaction machines.

In one primary embodiment of the present invention, the method of recharging a electronic cash device generally comprises the steps of (a) providing a transaction machine that has a machine body with a device (e.g.,) card reader and at least one of a display panel and a keypad on an outer surface of the machine body, with the card reader being configured to read the electronic cash device and the display panel and keypad being configured to transmit transaction information to or from the transaction machine; (b) reading the electronic cash device by the transactional machine to access a bank account or a credit limit associated with the electronic cash device and the authorized user; (c) entering into the transactional machine the amount of cash-equivalent funds that are to be transferred from the bank account or the credit limit to the electronic cash device; (d) electronically transferring the funds to the electronic cash device to establish available funds; and (e) accessing the available funds associated with the electronic cash device for a proposed transaction without accessing the bank account and the credit limit. The method of use can also comprise the step of comparing the proposed transaction to the available funds on the electronic cash device without accessing the bank account and the credit limit after the accessing step. In a preferred embodiment, the method further comprises the step of deducting the proposed transaction from the available funds after the comparing step. In an alternative embodiment, the transaction machine has a USB port on the outer surface of the machine body that is accessible to the authorized user while he or she is utilizing the transaction machine, with the USB port being configured to receive a USB drive and electronically communicate therewith. The method can further comprise the step of selecting the USB drive or an email address associated with the user to receive an electronic transaction receipt and transmitting the electronic transaction receipt to at least one of the USB drive or the email address after the electronically transferring step. The method can also comprise the step of inserting the USB drive into the USB port or the step of entering the email address into the transactional machine utilizing at least one of the display panel and the keypad prior to the transmitting step. The email address can be stored on the USB drive and associated with the authorized user.

Accordingly, one of the primary aspects of the present invention is to provide a system and method for allowing a user to lock and/or unlock a locking mechanism that has the advantages discussed above and which overcomes the disadvantages and limitations associated with presently available systems and methods for locking and unlocking locks.

It is an important aspect of the present invention to provide a system and method for allowing a user to access and control various functions of an automobile, such as the alarm system and door locks, that has the advantages discussed above and which overcomes the disadvantages and limitations associated with presently available systems and methods for accessing and controlling vehicle components that require the use of a key and/or a fob to control such components.

It is an important aspect of the present invention to provide a system and method that utilizes a microchip associated with the vehicle and a user of the vehicle that is configured such that a chip-reading mechanism in the vehicle will electronically engage the microchip, which may be in a cell phone or other device or embedded in the user, to automatically activate or deactivate the alarm and/or automatically lock or unlock one or more doors of the vehicle.

It is an important aspect of the present invention to provide a system and method for allowing a user to access and control various functions of an automobile which also allows the user to add funds to the microchip so the funds can be used to make purchases and other transactions without allowing access to the user's entire bank account balance and/or credit limit.

It is also an important aspect of the present invention to provide a system and method for adding funds to an electronic cash device that can be a debit/credit card, an appropriately configured USB drive or a microchip disposed in another device or implanted in the user's body.

It is also an important aspect of the present invention to provide a system and method for adding funds to electronic cash devices that substantially reduces or eliminates the ability of an unauthorized person to access all of the funds in a bank account or the entire credit limit associated with such a device.

It is also an important aspect of the present invention to provide a system and method for adding funds to an electronic cash device that allows the owner of the electronic cash device to add a desired amount of funds to his or her device at a transaction machine so that those funds, and only those funds and any previously added funds, would be available for purchases or other payments.

It is also an important aspect of the present invention to provide a system and method for adding funds to an electronic cash device that can be utilized with existing transaction machines and/or cash-equivalent devices, such as existing debit/credit cards, or with new transaction machines and/or new electronic cash devices that are configured to beneficially interact with each other to allow a user to add funds to his or her device.

It is also an important aspect of the present invention to provide a system and method for adding funds to a electronic cash device that can be utilized with transactions machines having a USB port and/or a keypad or touch screen to allow the user to obtain a paperless receipt for his or her purchases and other transactions to reduce the amount of paper produced by such machines.

It is also an important aspect of the present invention to provide a system and method for adding funds to a microchip, as the electronic cash device, disposed in another device or implanted in the user's body that also allows the user to activate/deactivate a vehicle's alarm system, lock/unlock the doors, trunk and/or fuel door of the vehicle, power on/off the engine and control other operational features of the vehicle.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

In the drawings which illustrate the preferred embodiments and the best modes presently contemplated for carrying out the present invention:

FIG. 1 is a front view of a transaction machine, debit/credit card and USB drive that are configured according to an embodiment of the system of the present invention and which utilizes the method of the present invention to add funds to the debit/credit card, as the electronic cash device, and provide a non-printed receipt for the user of the machine;

FIG. 2 is a schematic view of a system utilizing the machines and processes of the present invention;

FIG. 3 is a flow chart showing a method of utilizing the transaction machine to reduce or eliminate paper receipts;

FIG. 4 is a schematic chart showing the various associations between the components of the machine, system and method to reduce or eliminate paper receipts;

FIG. 5 is a schematic chart showing an embodiment of the system of the present invention to add funds to an electronic cash device;

FIG. 6 is a flow chart showing a method of utilizing the present invention to add funds to and use an electronic cash device;

FIG. 7 is a front view of transaction machine and debit/credit card, as the electronic cash device, configured for use with the system and method of the present invention;

FIG. 8 is a front view of a cell phone having a microchip disposed therein;

FIG. 9 is a front view of the palm of a user's hand showing a microchip implanted in the hand;

FIG. 10 is a flow chart showing a method of utilizing the present invention to add funds to and use a microchip, as the electronic cash device, in a device or embedded in a user;

FIG. 11 is a front view of a transaction machine having a chip-reading mechanism configured to read a microchip disposed in a device or implanted in a user;

FIG. 12 is a vehicle configured to be utilized with the system and method of the present invention which allows access to and control of the vehicle by a microchip disposed in a device or implanted in a user; and

FIG. 13 is a flow chart summarizing a method of utilizing the present invention to control various functions of a vehicle, including the alarm and door locks, with a microchip in a device or embedded in the user and a chip-reading mechanism associated with the vehicle.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of one or more preferred embodiments and, as such, disclose one or more different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein show certain configurations for the components of the system and method of adding funds to a rechargeable electronic cash device, those skilled in the art will readily understand that this is merely for purposes of simplifying the present disclosure and that the present invention is not so limited.

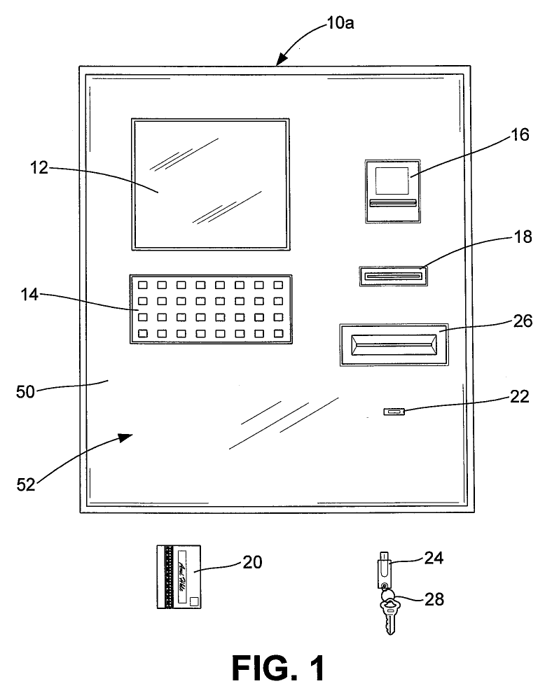

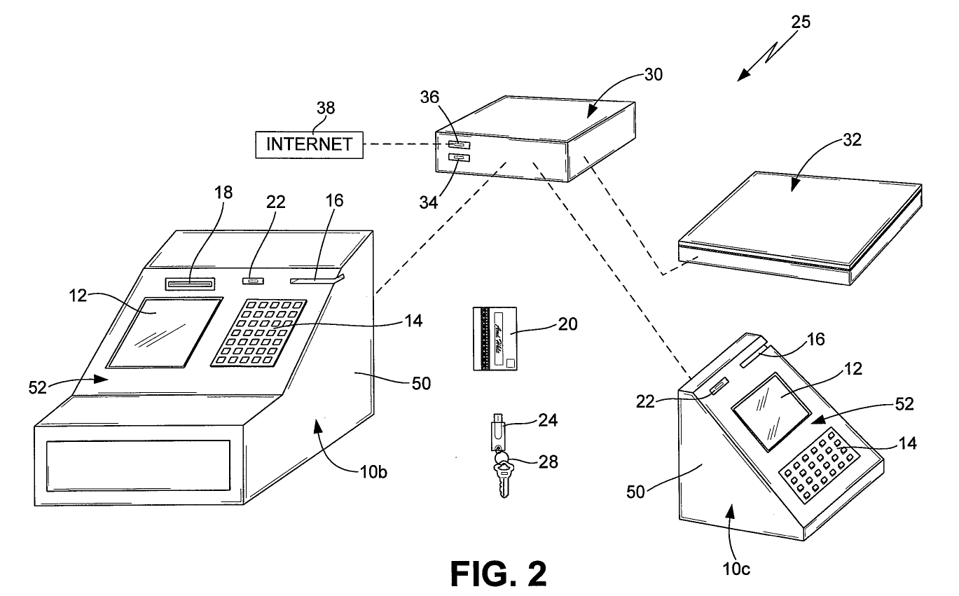

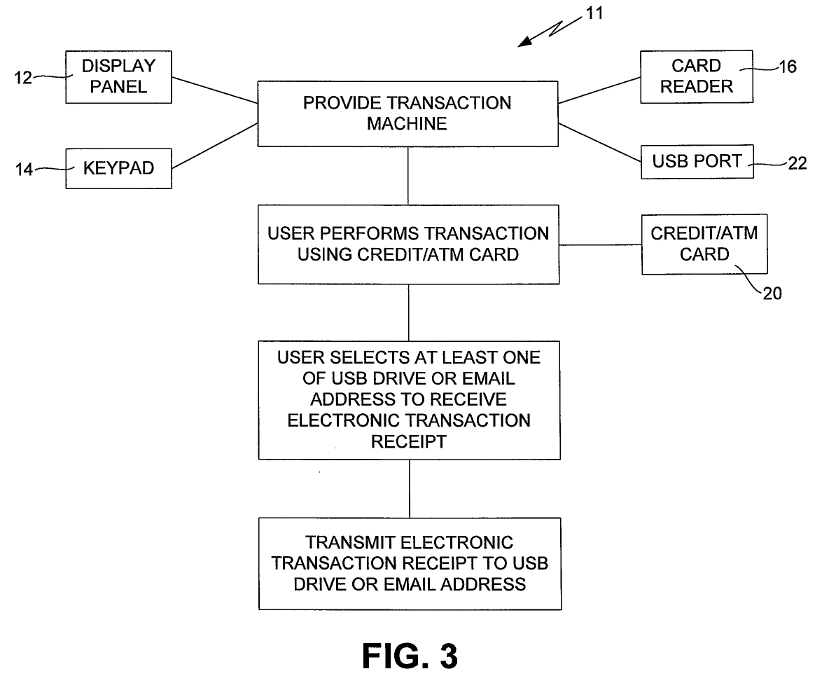

Transaction machines that are beneficially configured for use with one embodiment of the present invention is shown generally as 10 in FIGS. 1 and 2. As with presently configured transaction machines, the transaction machines 10 of the present invention can be utilized to purchase goods and/or services or to transact business with a bank or other financial institution. As shown in FIG. 1, in one embodiment the transaction machine 10 is configured as an ATM-type machine, shown as 10a, comprising a machine body 50 having an outer surface 52 with a display panel 12, a keypad 14, a card reader 16 and a paper receipt dispenser 18 (as is typical with standard transaction machines). In FIG. 2, the transaction machines are a cash register type of machine 10b and a customer input/payment machine 10c. For purposes of the present disclosure, the above transaction machines and all related transaction machines are herein referenced collectively by the numeral 10 and, when relevant, specifically by 10a, 10b or 10c. The method of utilizing a transaction machine 10 with a debit/credit card for paperless receipts is shown as 11 in FIG. 3. As will be readily apparent to those skilled in the art, the transaction machine 10 and the method 11 of its use is not limited to the machines 10a, 10b or 10c shown or otherwise set forth in FIGS. 1 through 4. Instead, the various principles and processes of the paperless receipt invention can be incorporated into a wide variety of transaction machines 10 which are utilized by people to transact business or accomplish other transactional type objectives.

As familiar to those who utilize presently available transaction machines, typically a debit (i.e., ATM) card or credit card 20 (hereinafter referred to as debit/credit card 20) is utilized by the user 21 to access the transaction machine 10 and purchase the desired goods and/or services or to obtain cash from the transaction machine or otherwise conduct business with a financial institution. As explained in more detail below, several of these standard features are modified for the machine 10 and method 11. As shown in FIGS. 1 and 2, the transaction machine 10 of the present invention has a USB port 22, configured to receive and operatively connect with a USB drive 24 that is associated with the particular user 21 of machine 10. The USB drive 24 is a standard data storage device that is inserted into the USB port 22 to receive and store transactional information from transaction machine 10 for later retrieval by the user. Although the transaction machine 10 preferably utilizes USB port 22 and USB drive 24 for the paperless receipt function, due primarily to the availability and popularity of these devices, the paperless receipt invention is not so limited. Instead of USB drive 24, machine 10 of the present invention can be utilized with other small, portable data storage devices, which may be configured similar to USB drive 24, for receiving and storing data from machine 10 having a port or other device-receiving receptacle that is configured to transfer data between the machine 10 and the portable data storage device. Preferably, the paper receipt dispenser 18 will rarely be utilized in favor of the improvements provided by the machine 10 and method 11, which are the subject of co-pending U.S. patent application Ser. No. 12/573,872 file by the same inventor (the above-identified patent application is hereby incorporated herein as though fully set forth herein). Over time, as people become more familiar with the new transaction machines 10 and the method 11 of using the machine 10, it should be possible to eliminate (phase out) the paper receipt dispenser 18.

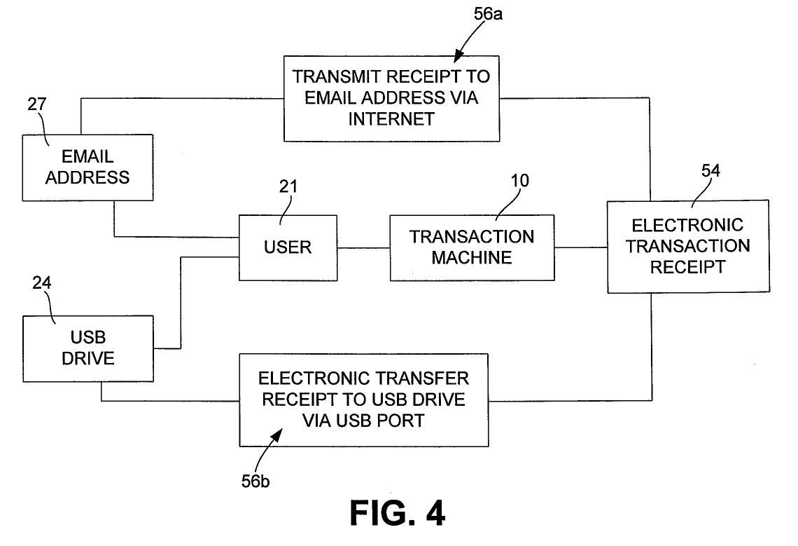

As with standard transaction machines, the transaction machine 10 of the present invention is initially accessed, at outer surface 52 of machine body 50, by the user 21 by inserting his or her debit/credit card 20 into the card reader 16. The user 21 enters the required passwords or other codes by utilizing keypad 14. Information relevant to the transaction is displayed at the display panel 12. Some transaction machines 10 may combine the features of the display panel 12 and the keypad 14 by utilizing touch-screen technology. Display panel 12 and keypad 14 may be two separate components or they may be combined into a single, integral unit. As with standard transaction machines, user 21 can obtain a paper receipt from the paper receipt dispenser 18. Cash or other materials are dispensed through the cash dispenser 26. The advantage of the transaction machine 10 and method 11 of paperless receipts is that the need to have a paper receipt is preferably eliminated by utilizing USB port 22 and drive 24 or an email address 27, shown in FIG. 4, that is associated with the user 21 to obtain the desired transaction information, which is in the form of an electronic transaction receipt 54.

As will be readily understandable to those familiar with USB ports and drives, the user 21 of transaction machine 10 inserts his or her USB drive 24 into the USB port 22 to establish a connection between the USB drive 24 and the transaction machine 10. With the connection established, electronic transaction receipt 54 can be transferred to the USB drive 24 for storage thereon instead of to the paper receipt dispenser 18, thereby eliminating the paper receipt and the waste of ink and paper associated therewith. In one embodiment, the USB drive 24 can be small so the user 21 can easily carry it with him or her (i.e., using an attached key chain ring 28 or other carrying means) for use with transaction machine 10. The user 21 can later review the receipt information stored on the USB drive 24 on his or her computer and, if desired, download it to a computer file for electronic filing or print a receipt for reimbursement or expense verification purposes. As such, the user 21 will be able to better track and retain the receipt because he or she will be at the home or office where it is easier and, therefore, more likely to be properly filed or otherwise handled. The display panel 12 and/or keypad 14 can be modified to include the option to send the receipt information to the user's USB drive 24. In addition, the display panel 12 can display the receipt information, which for many people and/or transactions is likely to be the only receipt information that is needed or desired.

In addition or alternatively to the USB drive 24, the paper receipt can be eliminated by utilizing an email to send the electronic transaction receipt 54, typically via the Internet 38, to the user's email address 27 for later access at his or her computer. In this embodiment, the display panel 12 and/or keypad 14 is modified to provide alphanumeric keys so the user 21 can enter in his or her email address 27 and to provide the option to the user 21 to send the receipt information to his email account. If the user 21 selects this option, the electronic transaction receipt 54 is emailed to the email address 27 entered by the user 21. Alternatively, or in addition thereto, the email address 27 of user 21 can be associated with his or her bank or other account (i.e., gasoline or store account) so the user 21 does not have to enter the email address 27 each time he or she makes a transaction at the transaction machine 10. In another embodiment, the user's email address 27 can be associated with (e.g., electronically or embedded on) his or her debit/credit card 20 so the user does not have to enter the email address 27. Instead of debit/credit card 20, the transaction machine 10 can be configured for use with other small, portable account access devices and have an appropriately configured reader for exchanging information between the device and machine 10. In yet another embodiment, the email address 27 can be associated with a user's USB drive 24. In one configuration of this embodiment, USB drive 24 can have a file or other identifying means thereon for associating the user's USB drive 24 with his or her account(s) that allows the transaction machine 10 to retrieve, automatically or by user authorization, the user's email address 27 from USB drive 24. In the above embodiments, the user only has to select the email receipt option displayed on display panel 12 and the electronic transaction receipt 54 will be automatically sent to his or her email address 27. As with the USB drive storage option described above, the electronic transaction receipt 54 can then be reviewed on the user's home/business computer and, if desired, downloaded to a computer file for electronic filing, emailed to a corporate or other office or printed if a written record is needed for reimbursement or expense verification purposes.

The transaction machine 10 will include a means 56 for transmitting the electronic transaction receipt 54 to at least one of the user's email address 27 or the user's USB drive 24. In one embodiment, the transmitting means, shown as 56a in FIG. 4, is the Internet 38. As shown, the electronic transaction receipt 54 is transmitted to the user's email address 27 via the Internet 38, or by other appropriate online data transfer system, utilizing the appropriate electron medium and software, both of which are well known in the art. If the user 21 selects the USB drive 24, instead of or in addition to the email address 27, the electronic transaction receipt 54 is transferred to USB drive 24 via the USB port 22 utilizing internal electronic transfer processes that are also well known in the art.

A typical system 25 using the transaction machines 10 for paperless receipts is illustrated in FIG. 2. In the system shown, the transaction machines are a cash register machine 10b and a customer input/payment machine 10c. As shown, these two machines 10b and 10c are connected to a central or host CPU 30 that provides computer capabilities for the system. The transaction machines 10, which can include other types of machines, are connected to the CPU 30 using conventional and readily available, whether presently or in the future, wired or wireless connection means. The CPU 30 is utilized for on-site storage of the transaction data and for storage of user information, such as his or her email address 27 and other contact and/or purchase information. As set forth in more detail below, the user's email address 27 can be utilized for mass or single email solicitations and notices of special events and promotions. Also connected to CPU 30 is a data input device, such as a scanner 32, for use to send camera ready flyers to add sparkle or otherwise jazz-up the company's solicitation. As with transaction machine 10, the scanner 32 or other device may be wired or wirelessly connected to the CPU 30. Preferably, CPU 30 has a input connector 34 that allows the owner or user of transaction machine 10 to connect a second computer, such as a laptop computer, desktop computer or the like, to the CPU 30 so he or she can access the data on the CPU 30 as necessary or desired. The CPU 30 should include an Internet connection port 36 that allows the owner/operator to connect, via a wired or wireless connection, to the Internet 38. This will allow the owner/operator to send email receipts and promotions to users 21, using email data collected by the transaction machines 10 and from other sources, and access various other Internet-related services. In addition, by utilizing appropriately configured software, the owner/operator can remotely access the CPU 30 to perform various functions related thereto.

In addition to the advantages to the user of the transaction machine 10 and method 11 of paperless receipts, there are also advantages to businesses that own, operate or which are accessed by the transaction machine 10. One advantage is that the business will be able to promote the fact they are going “green” and their commitment to being environmentally friendly. Another, perhaps more important advantage, is that the business using the transaction machine 10 will be able to utilize the user's email address 27 or other information associated with user 21 to promote the business's products and or services to the user 21. The transaction machine 10 can be configured to collect the email addresses 27 of users 21 that use the machine 10 and transmit that information to the bank or other business (i.e., gasoline or other company which is utilizing the transaction machine 10). The business then can use the email address 27 to send promotional offers, such as coupons and the like, or other information, such as notice of special sales or the like, to the user 21 to encourage him or her to purchase the business's products and/or services. Transaction machine 10 and method 11 of paperless receipts will significantly improve contact with the business's customers or potential customers.

The user 21 will generally utilize the transaction machine 10 in much the same way he or she uses presently configured transaction machines. Instead of having to receive a paper receipt through paper receipt dispenser 16, however, user 21 can receive an electronic transaction receipt 54 information that verifies the transactions in one or more ways, such as: (1) visually on the display panel 12; (2) stored on his or her USB drive 24 through the USB port 22; or (3) via his or her email address. This will reduce the waste of ink and paper presently associated with the receipt printed from the paper receipt dispenser 16 and provide the user 21 with a more effective receipt for reimbursement or other expense verification purposes. The business using the transaction machine 10 and process of the present invention can promote going “green” and utilize the transaction machine 10 to collect email addresses 27 of users 21 of transaction machine 10 so they can promote their products and/or services to these users 21, which will benefit both the businesses and users 21.

Various modifications can be made to the transaction machine 10 and method 11. For instance, the machine 10 can be configured for wireless transmission to the USB drive 24 or a different type of data storage device, such as a hand-held computing device, laptop or telephone for later review and/or printing. In another modification, the USB drive 24 can be configured such that it is utilized in the same manner as a credit/ATM card 20, which would eliminate the need to carry the a credit/ATM card 20. Instead of inserting or sliding the credit/ATM card 20 through the card reader 16, the user 21 would merely insert the USB drive 24 into the USB port 22. The transaction machine 10 would “read” or otherwise acknowledge the USB drive 24 and then require the user 21 to enter in his or her password, in much the same way as presently done with credit/ATM cards 20. After the correct password is entered, the user can accomplish the desired transaction and then store the transaction receipt information on the USB drive 24 and/or have the information sent to his or her email address 27 which, as set forth above, can be associated with his or her account, entered by the user 21 at display panel 12 and/or keypad 14, or read from the USB drive 24.

In another embodiment, the USB drive 24 or other data storage device (such as an “e-card” or the like) can be utilized as a universal charge, identification and storage device. For instance, the user's driver's license can be stored on the USB drive 24, preferably by going to the appropriate state agency or its website, and having the appropriate information placed on the USB drive 24. The user's credit card, debit card and other charge card information can also be stored on the USB drive 24 by the financial institution, via in person or through their website. To further improve functionality and convenience for the user, his or her health or gym club, private or business association, casino membership and/or other information can be placed on the USB drive 24. To ensure security for the user's information, personal identification and alphanumeric characters can be embedded on the USB drive 24 or other e-card. To further improve security, the USB drive 24 can contain a photograph of the user so his or her identity could be verified by the business or other organization accepting use of the USB drive 24. When the card is inserted into machine 10, a user screen could appear on the display panel 12 to allow the user to select the desired credit, debit or charge card which to complete the desired transaction (after the user's identification and password are verified). The transaction information is then stored on the USB drive 24 for later storage, printing or other use at the user's home and/or business location. When the transaction information is downloaded or printed, the user can remove if from the USB drive 24 to make room for additional information. All original credit, debit or other cards can be stored at a safe location desired by the user. Back-up data on the USB drive 24 can be stored on any computer. To assist with retrieval of a lost USB drive 24, it can contain information regarding the user and a reward or other enticement notice to encourage the finder to return the USB drive 24 to the user. Any such notice could be displayed when the USB drive 24 is inserted into the USB port 22, at the time the secret identification and password are required to be entered. A major advantage of the utilizing a single USB drive 24 with all of the user's credit, debit or other card information is that it would eliminate the need to carry large, bulky and generally unmanageable wallets that have to contain all the cards the user may want to use. Instead, the user can carry a single money clip or like object.

In another embodiment, the user's card and other data can be placed on a very small microchip or other small portable storage device which is implanted in the human body. As with the USB drive 24 described above, the microchip will be configured to store data thereon and then exchange the data with a machine 10 that has a reading device that is capable of accessing the microchip by swiping, scanning or otherwise reading it with a fixed, wired, infrared or like device. As with the above, the machine 10 will display information on the display panel 12 so the user can select which card will be utilized for the transaction. The microchip will have the user's identification and password to protect use of the information thereon. The information could include the user's driver's license, health insurance, club and other information. The use of the microchip would replace all of the user's cards, thereby eliminating problems that presently arise from loss of a wallet or purse having such cards. With the use of the implanted microchip, the user will not have to worry about losing his or her valuable information, whether by misplacing it or as a result of theft. In addition, the use of the microchip eliminates the need for the bulky wallet that most people presently carry.

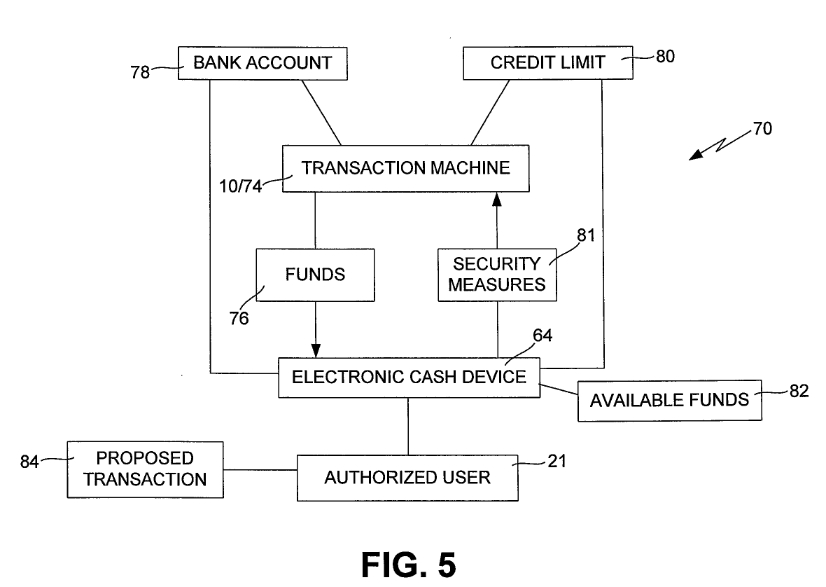

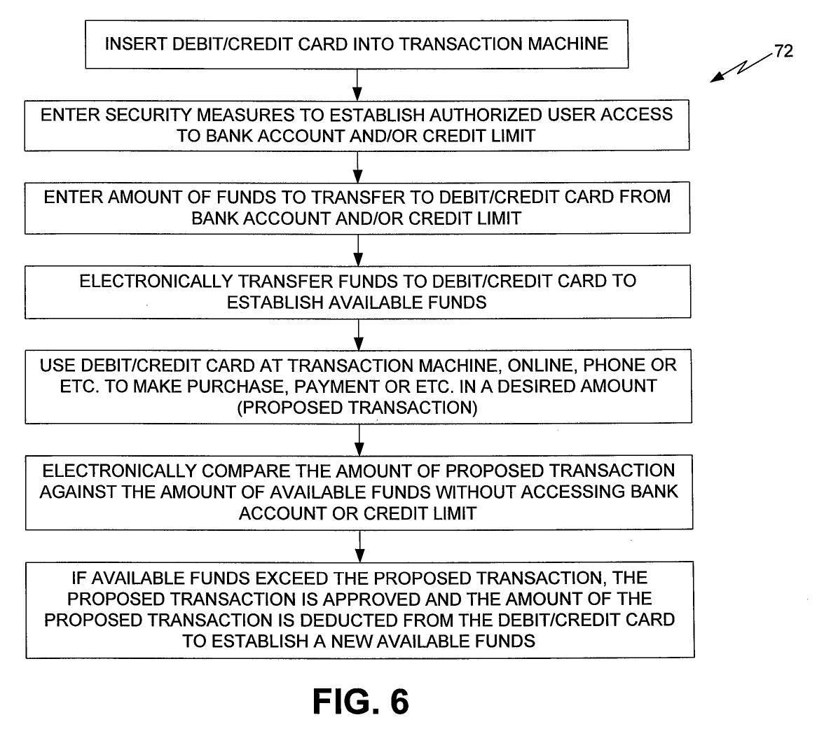

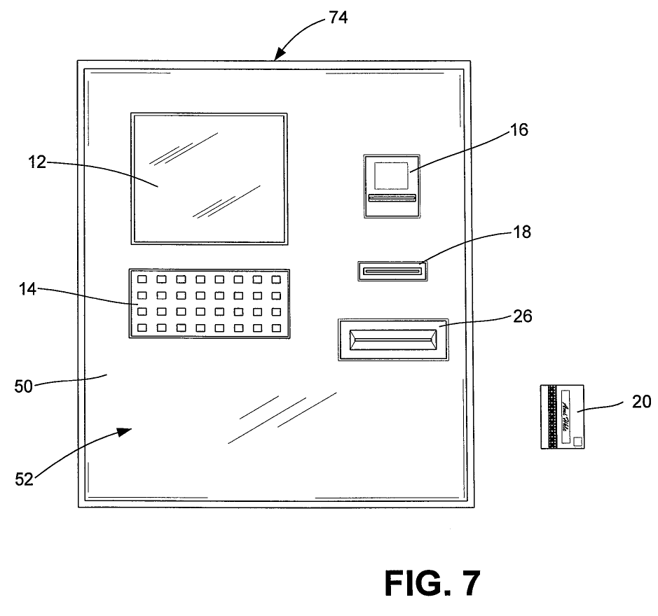

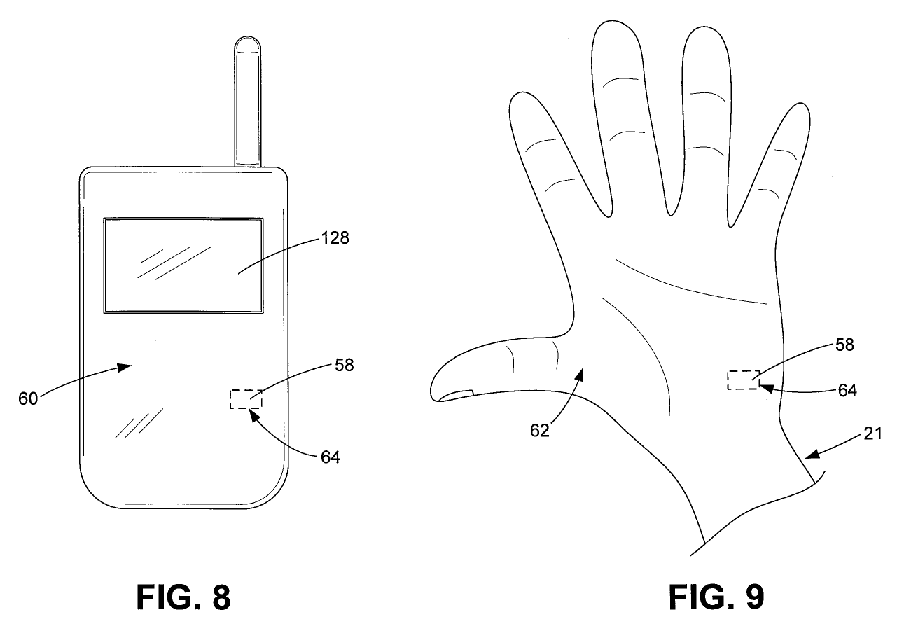

The present invention provides an improved system and method of utilizing cash-equivalent electronic cash devices, such as a debit/credit card 20, an appropriately configured USB drive 24 or a microchip 58. As shown in FIGS. 8 and 9, the microchip 58 can be disposed in a device 60, typically a small card like device that can fit in a wallet or at least a small hand-held device (such as the cell phone shown in FIG. 8) that carries or is particularly configured for carrying the microchip 58, or the microchip 58 can be implanted somewhere in the user's body, such as his or her hand (shown as 62 in FIG. 9). The debit/credit 20, USB drive 24, device 60 and other devices used with the system 70 and method 72 of the present invention are collectively referred to herein as electronic cash devices 64. One embodiment of the rechargeable cash replacement system of adding cash-equivalent funds (i.e., recharging) the user's electronic cash device 64 of the present invention is shown as 70 in FIG. A method of using the system components to add funds to an electronic cash device 64 (with the electronic cash device 64 identified as debit/credit card 20) is shown as 72 in FIG. 6. The user 21 is the owner/holder of electronic cash device 64 or someone acting on his or her behalf and with his or her permission. Although not required, in one embodiment of the present invention system 70 and method 72 are configured to also be utilized with the transaction machine 10 and method 11 for paperless receipts, as shown in FIGS. 1 and 3. In another embodiment, the transaction machine (shown as 74 in FIG. 7) does not have the USB port 22 or any other mechanism for obtaining paperless receipts (e.g., configured as a standard transaction machine with only the paper receipt dispenser 18) and is utilized by user 21 with debit/credit card 20, as the electronic cash device 64. In either embodiment, transaction machines 10 and 74 for use with the present invention are configured similar to prior art transaction machines except that the machine 10/74 and debit/credit card 20 are cooperatively configured such that transaction machine 10/74 can place funds, shown as electronic funds 76 in FIG. 5, onto debit/credit card 20 in addition to just reading the debit/credit card 20 as is presently done. As set forth in more detail below and shown in FIG. 5, the funds 76 placed on debit/credit card 20 will typically come from the user's bank account 78 (for debit cards) or a portion of his or her credit limit 80 (for credit cards). As shown in FIG. 7, in one embodiment the transaction machine 74 is configured as an ATM-type machine comprising a machine body 50 having an outer surface 52 with a display panel 12, a keypad 14, a card reader 16, a paper receipt dispenser 18 and a cash dispenser 26 (as is typical with various prior art transaction machines and transaction machine 10). As set forth above, the transaction machine 74 can be configured as a cash register type of machine 10b, a customer input/payment machine 10c or the like. Alternatively, transaction machine 74 can be specially configured with a minimum amount of components (e.g., just a touch display panel 12 and card reader 18) and only be utilized for the system 70 and method 72 of the present invention. For purposes of this disclosure, the above transaction machines and all related transaction machines are referenced collectively by numeral 74. As will be readily apparent to those skilled in the art, the transaction machine 74 and the method 72 of its use is not limited to the machines shown or otherwise set forth herein. Instead, the various principles and processes of the present invention can be incorporated into a wide variety of differently configured transaction machines 74 which are utilized by people to transact business or accomplish other financial and transactional type of objectives.

As well known in the art, presently configured transaction machines do not electronically or physically place data of any kind, including no electronic funds, onto debit/credit card 20 or any other electronic cash device 64. Instead, the machines just read account-related information from the debit/credit card 20 and allow the user to access information regarding the bank account 78 or credit limit 80 electronically stored by the user's bank or credit card company. When making a purchase or otherwise using the debit/credit card 20, the amount of the proposed transaction is checked against the funds that are available in the bank account 78 associated with card 20 or the credit limit 80 of card 20. If the desired amount of funds or credit are available, the transaction is allowed to proceed and the user 21 completes his or her financial transaction, such as paying for the goods or services. If the funds are not available, the purchase is typically declined and the user 21 cannot complete his or her purchase. As set forth above, in the prior art system and method, the entire bank account 78 or credit limit 80 is available to the user of the debit/credit card 20. If a thief or other unauthorized user gains access to the card 20 or the ability to use card 20 (e.g., from an online transaction), then he or she may be able to access the entire amount of funds in the bank account 78 or the entire credit limit 80 associated with the card 20. Naturally, this can result in substantial financial loss to the authorized user 21 (i.e., the card holder or owner) of debit/credit card 20.

The system 70 and method 72 of the present invention allow the user to have a sufficient amount of funds available on his or her electronic cash device 64 (e.g., debit/credit card 20, USB drive 24 or microchip 58) to make the desired purchase without risking access to his or her entire bank account 78 or credit limit 80. Transaction machine 10/74 is configured to electronically engage the electronic cash device 64. In one embodiment, shown in FIGS. 5 through 7, the authorized user 21 inserts his or her debit/credit card 20 into the card reader 16 of the transaction machine 10/74. In another embodiment, the card reader 16 is of the type where the authorized user 21 swipes his or her debit/credit card 20 through the card reader 16. In either embodiment, the transaction machine 10/74 reads the debit/credit card 20. Transaction machine 10/74 will then require the authorized user 21 to enter his or her password or utilize other provided security measures, shown generally as 81 in FIG. 5, to ensure that the person using the debit/credit card 20 is the authorized user 21. Once transaction machine 10/74 approves the use of debit/credit card 20, the user 21 enters the amount of funds 76 he or she wishes to be placed on the debit/credit card 20 from his or her bank account 78 and/or credit limit 80. Once the debit/credit card 20 loaded with the desired amount of available funds 76, authorized user 21 will have the funds 76 available on the debit/credit card 20 for purchases and/or payments to others. To make a purchase or payment, the authorized user 21 will insert or swipe the debit/credit card 20 into or through the card reader 16 of a transaction machine 10 at the point of purchase or payment. After entering or otherwise complying with the required security measures 81, the funds 76 on debit/credit card 20 are electronically reduced by the amount of the purchase/payment and the vendor or other payee electronically receives the payment. The funds remaining on the debit/credit card 20 can be utilized for other purchases and/or payments. The authorized user 21 can utilize display panel 12 or keypad 14 of the transaction machine 10/74 to download or otherwise transfer an electronic transaction receipt 54 to the debit/credit card 20, a USB drive 24 and/or an email address so that he or she may have a record of the electronic transactions, such as the amount of funds loaded onto the debit/credit card 20, where the funds came from and/or the data regarding the user's purchases and payments. As set forth above, this will eliminate the waste and other problems associated with paper receipts.

In another embodiment of the method 72 of the present invention, user 21 will insert USB drive 24 (as the electronic cash device 64) into the USB port 22 of an appropriately configured transaction machine, such as transaction machine 10 shown in FIG. 1, to transfer the desired amount of “cash” to the USB drive 24 from bank account 78 or credit limit 80. Using his or her password or other security measures 81, the user 21 transfers the desired amount of funds 76 to the USB drive 24. Once USB drive 24 is loaded with the desired amount of available funds 76, user 21 will remove the USB drive 24 and have the funds 76 available for purchases and/or payments to others. To make a purchase or payment, the user 21 will insert his or her USB drive 24 into the USB port 22 of a transaction machine 10 at the point of purchase or payment. After entering or otherwise complying with the required security measures 81, the funds 76 on the USB drive 24 are electronically reduced by the amount of the purchase/payment and the vendor or other payee electronically receives the funds. The funds remaining on USB Drive 24 can be utilized for other purchases and/or payments. If desired, the authorized user 21 can utilize the display panel 12 or keypad 14 of the transaction machine 10/74 to download or otherwise transfer an electronic transaction receipt 54 to the USB drive 24 or to an email address so that he or she may have a record of the electronic transactions, such as the amount of funds loaded onto USB drive 24, where the funds came from and/or the data regarding the purchases and/or payments that he or she made utilizing the USB drive 24. As set forth above, this will eliminate the waste and other problems associated with paper receipts.

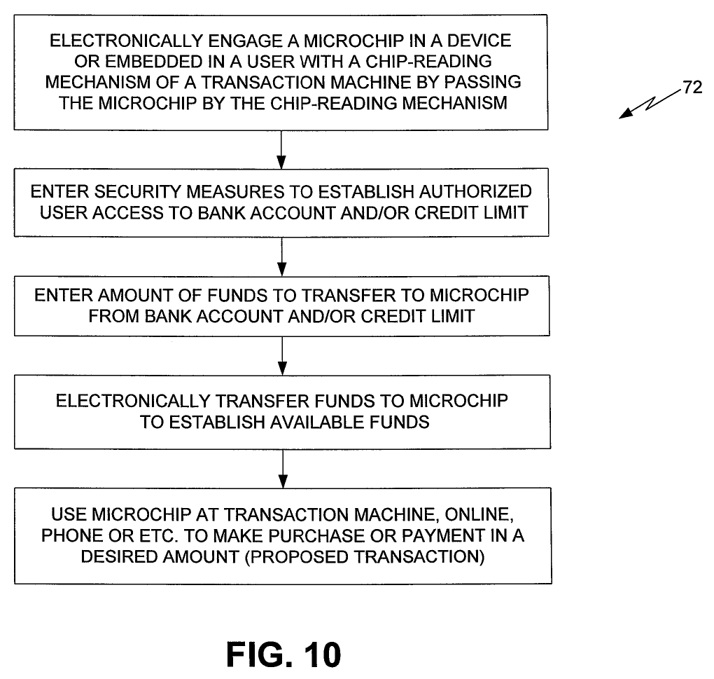

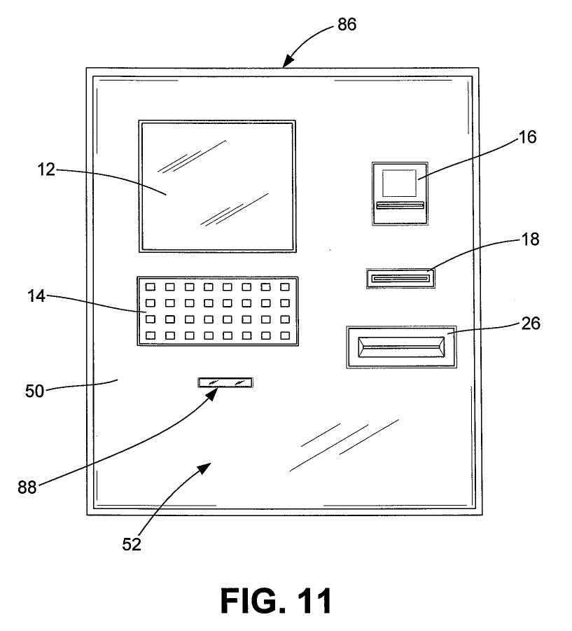

In yet another embodiment of method 72 of the present invention, which is summarized in FIG. 10, electronic cash device 64 comprises a microchip 58 placed inside or on a device 60 (which could be a card 20 or USB drive 24, among other devices) or physically embedded in the user 21. As set forth below, the microchip 58 is utilized with a transaction machine, shown as 86 in FIG. 11, which comprises a chip-reading mechanism 88 that is configured to read the microchip 58, included in/on device 60 or embedded in user 21, by electronically engaging the microchip 58. In one embodiment, the chip-reading mechanism 88 is capable of electronically reading microchip 58 without having to make physical contact with the device 60 or user 21. In such an embodiment, the transaction machine 86 can be configured to read and otherwise interact with the data on microchip 58 when the user 21 waves, swipes or otherwise passes the microchip 58 (in device 60 or embedded in the user 21 himself/herself) across or near the chip-reading mechanism 88. Mechanisms which can electronically read bank-type data and other electronic information on a microchip, such as microchip 58, by having the microchip be passed over, under or otherwise near the mechanism are generally well known in the industry. Many such mechanisms will be suitable for use as chip-reading mechanism 88. In use, as summarized in FIG. 11, the user 21 will electronically engage a transaction machine 86 (typically by passing microchip 58 that is in or on device 60 or embedded in user 21 across, over or under chip-reading mechanism 88) to transfer the desired amount of “cash” to the microchip 58 from the user's bank account 78 or credit limit 80. Using security measures 81, the user 21 transfers the desired amount of funds 76 to microchip 58 to load it with the desired amount of available funds 76 so that those funds 76 will be available for purchases and/or payments to others. To make a purchase or payment, user 21 will electronically engage the chip-reading mechanism 88 of a transaction machine 86, typically by passing the microchip 58 (in device 60 or embedded in the user 21) across, over or under the chip-reading mechanism 88 at the point of purchase or payment. After entering or otherwise satisfying the required security measures 81, the funds 76 on microchip 58 are electronically reduced by the amount of the purchase/payment and the vendor or other payee electronically receives the funds. The funds remaining on microchip 58 can then be utilized for other purchases and/or payments. When desired or necessary, the funds on microchip 58 can be “reloaded” from a transaction machine 86. The authorized user 21 can utilize the display panel 12 or keypad 14 of transaction machine 10 to download or otherwise transfer an electronic transaction receipt 54 to the microchip 58 in device 60 or embedded in authorized user 21 or send it to an email address. In this manner authorized user 21 will have a record of the electronic transactions, such as the amount of funds loaded onto microchip 58, where those funds came from and/or the data regarding the user's purchases and payments that he or she made utilizing microchip 58. As set forth above, this will eliminate the waste and other problems associated with paper receipts.

As set forth above, transaction machine 10/74/86 will electronically engage the electronic cash device 64 to either transfer “cash” to the electronic cash device 64 or to allow the authorized user 21 of the electronic cash device 64 to make purchases, payments and the like by deducting funds from the electronic cash device 64. Among other possible mechanisms, the transaction machine 10/74/86 can electronically engage the electronic cash device 64 by having the electronic cash device 64 inserted into a card reader 16 or USB port 22, swiped through a card reader 16, passed across (such as over, under or to the side of) a chip-reading mechanism 88, be positioned near a chip-reading mechanism 88 or the like. It is anticipated that there may be new mechanisms of having the data on the electronic cash device 64, which will include the funds on the electronic cash device 64 and information pertaining to the user's bank or credit card account(s), be electronically engaged by the transaction machine 10/74/86 for use with the methods and systems of the present invention. This electronic engagement will allow any such data to be transferred between the transaction machine 10/74/86 and the electronic cash device 64 during the loading or reloading and purchase/payment activities so as to accomplish the objectives of the present invention.

Unlike present systems and methods of using debit/credit cards, the system 70 and method 72 of the present invention transfers only those funds 76 desired to be associated with the electronic cash device 64 (i.e., debit/credit card 20, USB drive 24 or microchip 58). Funds 76 are electronically transferred to the electronic cash device 64 such that they are associated therewith when the user 21 utilizes electronic cash device 64 to make a purchase, payment or the like. The transferred funds 76 are added to the funds already on electronic cash device 64 to establish an amount of available funds 82, which the authorized user 21 can use at the transaction machine 10/74/86, to make online or telephone purchases/payments or other forms of use. When user 21 or any other person uses electronic cash device 64, the maximum amount of purchases or other payments, singularly or in total, is limited by the amount of funds 76 transferred to electronic cash device 64 by the authorized user 21 or someone acting on his or her behalf. In this manner, if electronic cash device 64 or the account information associated therewith is lost, stolen or otherwise ends up in with an unauthorized user, he or she will only be able to utilize the electronic cash device 64, if at all, up to the amount of funds 76 (or total available funds 82) placed on electronic cash device 64 by an authorized user 21 of electronic cash device 64. As such, the system 70 and method 72 of the present invention prevents an unauthorized user from accessing the entire bank account 78 and credit limit 80 that would otherwise be available with use of electronic cash device 64, thereby preventing the potentially substantial losses that can, and often do, occur with presently configured systems and methods of using debit/credit cards and the like.

When the authorized user 21 uses the electronic cash device 64, such as debit/credit card 20, to make a purchase, payment or the like, whether at transaction machine 10/74/86, online, on the phone or the like (referred to as the proposed transaction 84), the banking system or like organization that handles the subject electronic cash device 64 will electronically compare the amount of the proposed transaction 84 with the amount of available funds 82 to see if the purchase, payment or etc. can be approved. If the available funds 82 exceed the proposed transaction 84, the proposed transaction will be approved and the amount of the proposed transaction 84 will be electronically transferred to the vendor, payee or other person/entity and be electronically deducted from the electronic cash device 64 (such as debit/credit card 20), thereby reducing the amount of available funds 82. The user 21 can continue making purchases, payments or the like until the available funds 82 are not sufficient for any further desired purchases, payments or the like. At that time, or in advance if desired, the user 21 will repeat the process by utilizing transaction machine 10/74/86 to add funds 76 to the electronic cash device 64 to increase the amount of available funds 82. As such, utilizing system 70 and method 72 of the present invention, the user 21 can continually use the same electronic cash device 64 to make purchases, payments or the like, thereby avoiding the need to always have sufficient cash on hand or to use a check, but prevent access to his or her entire bank account 78 and/or credit limit 80 and, thereby, eliminate the potential significant financial risk or exposure that would otherwise be associated with such access. Because the electronic cash device 64 is rechargeable, system 70 and method 72 of the present invention avoids the waste of materials that are associated with fixed, pre-paid cards that many people presently utilize to avoid carrying cash or using a check.

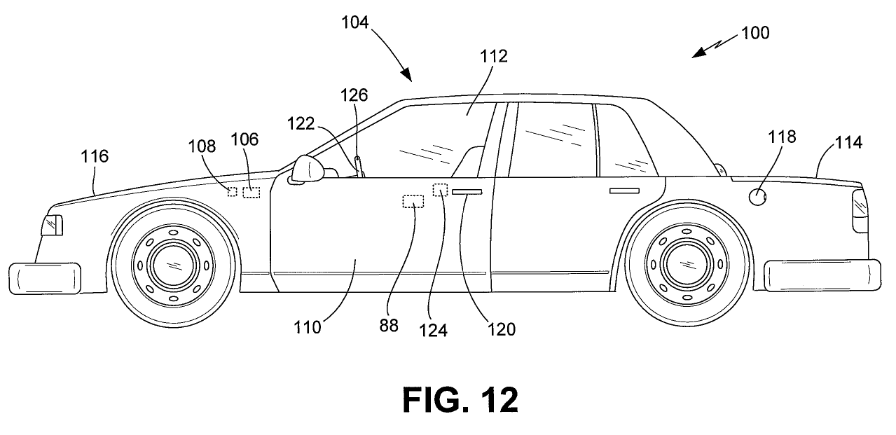

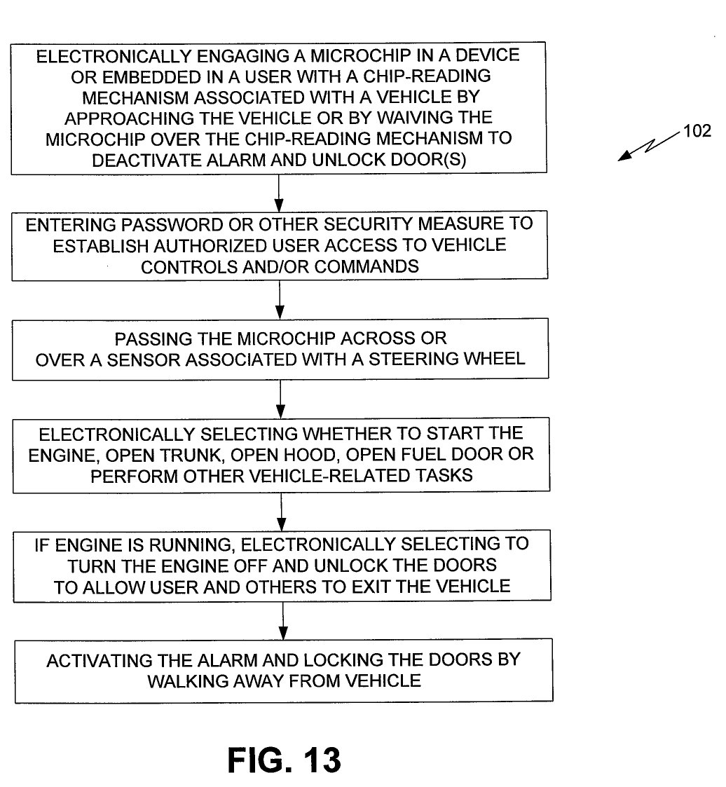

The microchip 58 in/on device 60 or implanted/embedded in user 21 can also be utilized with a new system 100 and method 102, shown in FIGS. 12 and 13, that allow user 21 to access and/or control various electronic functions of a vehicle 104, shown in FIG. 12, to eliminate the need for the user 21 to carry keys and/or a fob to have such access and/or control. As described above, the microchip 58 is configured to interact with a chip-reading mechanism 88 that is associated with transaction machine 86 so as to receive funds on the microchip 58 that can be used for a wide number of purchases and other financial uses. In the system 100 and method 102, the same microchip 58 allows the user 21 to accomplish various tasks with regard to the vehicle 104, as set forth in more detail below. As well known, most modern vehicles, such as vehicle 104, have an electronic controller, shown generally as 106 in FIG. 12, that allows the user 21 to electronically activate/deactivate an alarm 108, lock/unlock doors 110, lower/raise windows 112 and open trunk 114. Many electronic controllers 106 are configured to also unlock hood 116 so it can be opened by the user 21 for access to the engine compartment and/or unlock the fuel door 118 so the user 21 can add fuel to the vehicle 104. Once unlocked, the user 21 typically enters the vehicle 104 by utilizing a door handle 120 to open door 110 and enter the driver compartment of the vehicle 104 where he or she will sit behind the steering wheel 122 to drive the vehicle 104 to where he or she wants to go.

In the system 100 and method 102 of the present invention, at least some of the electronic functions of the vehicle 104 are engaged and controlled by the microchip 58. In addition to having the user's financial information, as set forth above, the microchip 58 would comprise information pertaining to the user's vehicle 104 and vehicle 104 would have a chip-reading mechanism 88 associated therewith that is configured to electronically engage the microchip 58 to allow the user 21 to perform certain functions. In one embodiment, microchip 58 can be configured to automatically activate or deactivate the alarm 108, preferably with a proximity circuit that will activate the alarm 108 after the user 21 moves further away than a certain distance, such as two to three feet or more, from the vehicle 104 and deactivate the alarm 108 when the user 21 approaches the vehicle 104. Those skilled in the art will readily appreciate that the chip-reading mechanism 88 and the electronic controller 106 can be easily configured to determine when the user 21 has walked away from vehicle 104 and when he or she is approaching the vehicle 104. When the chip-reading mechanism 88 senses the user 21 is walking away from the vehicle 104 it can send a signal to the electronic controller 106 to instruct it to activate the alarm 108 such that any improper attempt to enter the vehicle 104 will cause the alarm 108 to sound (as presently done). When the chip-reading mechanism 88 senses the user 21 is approaching the vehicle 104, such as when he or she is within two or three feet of vehicle 104, the chip-reading mechanism 88 can send a signal to the electronic controller 106 to instruct it to deactivate alarm 110. In an alternative embodiment, the chip-reading mechanism 88 of system 100 and method 102 can be configured to require the user 21 to waive or otherwise move the microchip 58, such as waving his or her hand 62, device 60 or USB drive 24, depending on where the microchip 58 is implanted, close to the chip-reading mechanism 88 (i.e., within a few inches thereof). This configuration can reduce the cost of the system 100 by eliminating the need for the various components that accomplish the proximity operations. In addition to lower cost, the requirement that microchip 58 be waived close to the chip-reading mechanism 88 may reduce any likelihood of any security breaches with regard to the system 100.

In addition to activating/deactivating the alarm 110, as described above, the system 100 and method 102 can be configured to also lock or unlock one or more of the doors 110 by controlling the operation of the vehicle's lock mechanism 124, preferably in conjunction with activating and deactivating alarm 108. In one embodiment, all doors 110 are locked but only the driver's door is unlocked. The locking mechanism 124 of vehicle 104 is electronically coupled to the electronic controller 106 such that a signal from the electronic controller will instruct the locking mechanism 124 to lock or unlock one or more doors 110 of the vehicle 106. As with alarm 108, the system 100 and method 102 can be configured to determine when the user 21 is moving away from vehicle 104 to lock the door(s) 110 and when the user 21 is moving towards vehicle 104 to unlock the door(s) 110 or, in the alternative configuration, when the user 21 is waiving the microchip 58 across or near the chip-reading mechanism 88. In a preferred configuration, chip-reading mechanism 88 and electronic controller 106 can be configured to accomplish both tasks at or about the same time, namely lock the doors 110 and activate the alarm 108 or unlock the doors 110 and deactivate the alarm 108. If desired, in addition to unlocking the door(s) 110, the system 100 and method 102 can be configured to “pop” open the driver's door 110 so he or she can more easily enter vehicle 104. In a preferred embodiment, the system 100 and method 102 are configured such that only the driver's door 110 unlocks and only the driver's door 110 opens. In an alternative embodiment, which can be selected by the user 21, one or more additional doors 110 can also open at the same time.

In another embodiment, the user 21 can utilize the microchip 58 to raise or lower the windows 112, open the trunk 114, open the hood 116 and/or open the fuel door 118. In a preferred configuration, microchip 58 electronically engages a sensor 126 located somewhere in the interior of the vehicle 104 to activate selective operation of one or more of the above-identified components of vehicle 104 on a device having a screen, preferably a touch-type screen or the like, that can be seen and acted upon by the user 21. In one embodiment, shown in FIG. 12, sensor 126 is located on the steering wheel 122 such that when the user 21 sits in the driver's seat he or she only has to waive the microchip 58, such as by waiving the device 60, USB drive 24 or hand 62 in which microchip 58 is located, over the sensor 126. Waiving the microchip 58 across the sensor 126 will initiate the process of allowing the user 21 to select which of the various operations will be initiated. The various options can be displayed on a screen, such as a screen in the vehicle 104 (i.e., a dash-mounted screen) or, if vehicle 104 does not have a dash-mounted screen, or the user 21 prefers, the screen 128 of device 60 (i.e., a cell phone), as shown in FIG. 8. If preferred, the system 100 can be provided with a voice-activated command prompts and answers to allow the user 21 to operate the system 100 and method 102 in a hands-free mode. The configuration and arrangement of components that are required to accomplish the foregoing are generally well known in the art.

In one configuration, the method 102 of the present invention would comprise, as set forth in FIG. 13, the following steps: (1) electronically engaging the microchip 58 in a device 60 or embedded in the user 21 with the sensor 126 so as to engage the chip-reading mechanism 88 by passing the microchip 58 across or over the sensor 126 in the steering wheel 122; (2) entering in a password or other security measure, as desired, to ensure the user 21 is the person utilizing the system 100; (3) selecting whether to utilize the voice activation system or not, such as by pushing once to activate it or pushing twice to not activate it, thereby using push-button controls; (4) selecting whether to power the engine on or to power the engine off, such as (as above) by pushing once to power the engine on and pushing twice to turn it off; (5) selecting to open the trunk 114; (6) selecting to open the fuel door 118; (7) selecting to open the hood 116; and (8) selecting whether to (a) activate the alarm 108 when exiting vehicle 104; or (b) exit vehicle 104 without activating the alarm 108. If desired, one of the selectable voice-activated commands can be whether the user 21 can raise/lower the windows 112 and/or unlock and/or open any of the doors 110, via locking mechanism 124, of vehicle 104 by just using his or her voice command. As will be appreciated by those skilled in the art, a wide variety of different commands can be initiated and/or activated using the system 100 and method 102 of the present invention. In addition, various components and arrangements of those components will be able to achieve the various objectives of the present invention.

Various components of the system 100 and method 102 can also be utilized to operatively control many other types of lock systems, other than just with a vehicle 104, that have a locking mechanism 124 that electronically controls one or more locks. For instance, the system 100 and method 102 can be utilized with locking systems that allow or forbid entry, by locking and unlocking one or more doors or other access points, into a house, office, store, storage unit or any other structure. As well known, many structures have an alarm system, such as the alarm 108 for vehicle 104, that are activated to prevent entry by sounding an alarm or sending an alarm signal if unauthorized entry occurs and are deactivated to allow authorized persons to enter the structure. As also well known, such systems have an electronic controller 106 that is electronically connected to the alarm 108 and to various access points throughout the structure being protected.

In an alternative embodiment of the system 100 and method 102, a chip-reading mechanism 88 can be utilized with electronic controller 106 such that activation or deactivation of the alarm 108 can be achieved using microchip 58, as described above in relation to vehicle 104. In such a system 100, either the proximity of the microchip 58 to the chip-reading mechanism 88 and/or the swiping or other passing of the microchip 58 across or near the chip-reading mechanism 88 will activate/deactivate the alarm 108 and/or lock/unlock one or more doors 110 of the structure. As with the above, the microchip 58 can be disposed in a device 60, such as a cell phone or the like, or USB drive 24 or it can be implanted in the body of the user 21, such as being embedded in his or her hand 62. When the chip-reading mechanism 88 senses the microchip 58 it will send an electronic signal to the electronic controller 106, which in turn will send an electronic signal to activate/deactivate the alarm 108 and/or to the locking mechanism 124 to lock/unlock one or more doors 110. As with current alarm systems, the system 100 can also be tied into a security firm or to the local police or sheriff to send an alarm signal when unauthorized entry of the structure has taken place. The system 100 and method 102 of this embodiment will eliminate the need for the user 21 to carry a key, fob or other item or to use a code or password in order to be able to enter the structure.

As with use of the system 100 and method 102 with vehicle 104, numerous modifications can be made to allow the user 21 or others to customize how the alarm 108 and/or doors 110 are controlled upon the presentation of the microchip 58. For instance, in one such modification the system 100 and method 102 can be configured to send a notification to the user, typically via a device 60 such as a cell phone or the like, that the security of the structure has been breached and that he or she should check on it and/or call the police or sheriff himself or herself. In this configuration, the user 21 may be able to eliminate the costs and fees associated with a security company.

In yet another embodiment, the system 100 and method 102 can be utilized with a wide variety of different locking mechanisms 124 that are utilized to prevent entry into a structure, safe, box, locker, yard or other area. For instance, it is well known that many people utilize padlock type locks to prevent entry into an area. Some padlocks require a key while others require the user to enter a combination to unlock the lock. In one embodiment of the present invention, the chip-reading mechanism 88 and electronic controller 106 would be incorporated into or otherwise closely associated with the locking mechanism 124 so the user merely has to pass the microchip 58, which can be in a device 60, USB drive 24 or in the user 21, over or near the locking mechanism 124 to unlock the locking mechanism 124 and allow entry into the area. In one configuration of this embodiment of system 100, the locking mechanism 124 can be configured similar to a conventional padlock type lock, but have the chip-reading mechanism 88 and the electronic controller 106 built into the lock. When the presence of microchip 58 is detected, either using its proximity to or by swiping/passing over the lock, the chip-reading mechanism 88 will send an electronic signal to the electronic controller 106, which in turn will send an electronic signal to locking mechanism 124 to lock/unlock the lock, as is appropriate, to allow/prevent entry into the area. As with the use of system 100 and method 102 with vehicle 104 or a structure, this embodiment will eliminate the need of the user 21 to carry a key for the lock and/or to memorize a code or password to open the lock.

While there are shown and described herein a specific form of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape and use. For instance, there are numerous components described herein that can be replaced with equivalent functioning components to accomplish the objectives of the present invention.

What is claimed is:

1. A vehicle control system, comprising:
a locking mechanism;
a microchip associated with said locking mechanism and a user of said locking mechanism, said microchip disposed in a device, a USB drive or implanted in said user; and
a chip-reading mechanism electronically connected to said locking mechanism and electronically associated with said microchip so as to associate said user with said locking mechanism, said chip-reading mechanism configured to lock and/or unlock said locking mechanism when electronically engaged with said microchip.

2. The system of claim 1, wherein said chip-reading mechanism is electronically connected to an alarm so as to associate said user with said alarm, said chip-reading mechanism configured to activate and/or deactivate said alarm when electronically engaged with said microchip.

3. The system of claim 1, wherein said chip-reading mechanism is disposed in or on a vehicle having at least one of an electronically controlled door and an electronically controlled alarm, said microchip configured to associate said vehicle with said user of said vehicle, said chip-reading mechanism disposed in or on said vehicle and electronically connected to at least one of said door and said alarm so said chip-reading mechanism will lock or unlock said door and/or activate or deactivate said alarm when electronically engaged with said microchip.

4. The system of claim 3, wherein said chip-reading mechanism is configured to determine the proximity of said user to said locking mechanism and/or if said user is approaching or exiting said vehicle when electronically locking or unlocking said door and/or activating or deactivating said alarm.

5. The system of claim 3 further comprising a sensor in said vehicle, said sensor configured to electronically engage said microchip and allow said user to select one or more commands.

6. The system of claim 5, wherein said one or more commands are accessed by the user on a screen.

7. The system of claim 6, wherein said screen is associated with said device.

8. The system of claim 6, wherein said commands allow the user to control operation of a motor and at least one of a trunk of said vehicle, a hood of said vehicle, a window of said vehicle and a fuel door of said vehicle.

9. The system of claim 1, wherein said chip-reading mechanism is configured to determine the proximity of said user to said locking mechanism.

10. The system of claim 1, wherein said microchip is electronically engaged with said chip-reading mechanism by passing said microchip across or near said chip-reading mechanism.

11. The system of claim 1, wherein said microchip is associated with a bank account and/or a credit limit associated with an electronic cash device and said user, said transaction machine configured to electronically engage said microchip and electronically transfer funds from at least one of said bank account and said credit limit to said microchip so as to establish available funds for use by said user for a proposed transaction.

12. The system of claim 11, wherein said email address is entered into said transactional machine utilizing at least one of said display panel and said keypad or said email address is electronically retrieved from a debit/credit card by said card reader, a USB drive through said USB port or from said microchip by said chip-reading mechanism.

13. A vehicle control system, comprising:
a vehicle having a door and an alarm that are electrically operated, said vehicle further comprising a motor and at least one of a trunk, a hood, a window and a fuel door that are electrically operated;
an electronic controller associated with said vehicle, each of said door and said alarm electronically connected to and controlled by said electronic controller;
a microchip associated with said vehicle and a user of said vehicle; said microchip disposed in a device, a USB drive or implanted in said user;
a chip-reading mechanism disposed in or on said vehicle and electronically associated with said microchip so as to associate said user with said vehicle, said chip-reading mechanism electronically connected to said electronic controller so as to operatively control said door and said alarm so said chip-reading mechanism will lock or unlock said door and activate or deactivate said alarm when electronically engaged with said microchip; and
a sensor in said vehicle, said sensor configured to electronically engage said microchip and allow said user to select one or more commands, said commands selected so as to allow said user to control operation of at least one of said motor, said trunk, said hood, said window and said fuel door

14. The system of claim 13, wherein said chip-reading mechanism is configured to determine the proximity of said user to said vehicle and/or if said user is approaching or exiting said vehicle when electronically locking or unlocking said door and/or activating or deactivating said alarm.

15. The system of claim 13, wherein said microchip is electronically engaged with said chip-reading mechanism by passing said microchip across or near said chip-reading mechanism.

16. The system of claim 13, wherein said one or more commands are accessed by the user on a screen.

17. The system of claim 13, wherein said microchip is associated with a bank account and/or a credit limit associated with an electronic cash device and said user, said transaction machine configured to electronically engage said microchip and electronically transfer funds from at least one of said bank account and said credit limit to said microchip so as to establish available funds for use by said user for a proposed transaction.

18. A method of accessing a vehicle having at least one door and an alarm, said method comprising the steps of:
a) providing an electronic controller electronically connected to at least one of said door and said alarm, said electronic controller electronically connected to a chip-reading mechanism associated with said vehicle;
b) providing a microchip associated with said vehicle and a user of said vehicle, said microchip disposed in a device, a USB drive or implanted in said user, said chip-reading mechanism configured to electronically engage said microchip;
c) electronically engaging said microchip with said chip-reading mechanism by approaching said vehicle and/or by waiving said microchip over the chip-reading mechanism to deactivate said alarm and/or unlock said door; and
d) activating said alarm and/or locking said door of said vehicle by walking away from said vehicle.

19. The method of claim 18 further comprising the step of passing said microchip over a sensor associated with said vehicle after said step of electronically engaging said microchip with said chip-reading mechanism, said vehicle further comprising a motor and at least one of a trunk, a hood, a window and a fuel door being electrically operated, said sensor configured to electronically engage said microchip and allow said user to select one or more commands, said commands selected so as to allow said user to control operation of at least one of said motor, said trunk, said hood, said window and said fuel door.

20. The method of claim 18, wherein said microchip is further associated with a bank account and/or a credit limit associated with an electronic cash device and said user and with a transaction machine configured to electronically engage said microchip and electronically transfer funds from at least one of said bank account and said credit limit to said microchip so as to establish available funds for use by said user for a proposed transaction, said method further comprising the step of electronically transferring said funds to said microchip after said activating step.
